(19) United States
(12) Patent Application Publication
(10) Pub. No.: US 2009/0083139 A1
(43) Pub. Date: Mar. 26, 2009

(54) SYSTEMS AND METHODS FOR SERVING GENERALIZED GIFT CERTIFICATES TO CONSUMERS ON A WEB SITE

(75) Inventor: Dmitry Yurievich Pavlov, San Jose, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/860,603

(22) Filed: Sep. 25, 2007

(51) Int. Cl. G06Q 40/00

(52) U.S. Cl. 705/14

(57) ABSTRACT

A system and method for providing generalized gift certificates, the generalized gift certificates allowing a user to purchase goods and services from one or more merchants in a merchant network via a redemption center. The redemption center utilizes user information and user target parameters to recommend merchants to the user and to target advertisements to users who have received one or more generalized gift certificates.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of electronic commerce, and more particularly to systems and methods for serving generalized gift certificates to consumers on a web site.

### BACKGROUND

The popularity of the internet and the ability for consumers to securely provide their payment information to merchants led to the massive increase of electronic commerce that the world has experienced over the past decade. As the number of potential customers on the internet increased, so did its attractiveness to merchants as a vehicle for advertising. Early attempts at advertising on the internet consisted of banner advertisements displayed on web sites and the infamous “pop-up” advertisement. These attempts quickly became ubiquitous and thus did not provide much in the way of valuable traffic to the advertisers.

Various methods have been introduced to target internet advertising by tailoring the advertisements displayed to each user based upon the user's interests. Search advertising is one method that has proven highly effective at increasing the value of traffic sent to a web site. When a user initiates a web search using a search engine, such as the Yahoo! search engine (http://www.yahoo.com), the user is inherently indicating to the search engine what he is interested in at that moment. By way of example, without limitation, if a user searches for “snow shoes” and the search engine displays an advertisement for a snow shoe store amongst the search results, the user is more likely to follow the advertisement to the snow shoe store, thus increasing the value of the traffic coming from the search engine to the snow shoe store.

Contextual advertisements are another method for increasing the value of traffic generated by online advertising. Contextual advertisements are embedded in web sites and display advertisements that are relevant to the content of the web page in which they are embedded. Advertisers can pay to have their products or web site displayed when certain keywords appear in the web page. By way of example, without limitation, a contextual advertisement embedded in a web site that allows users to review products could display advertisements for those or competing products, thus increasing the value of the traffic coming from the review web site to the advertiser.

### SUMMARY

The instant disclosure is directed to systems and methods for serving generalized gift certificates to consumers on a web site that increases the value of traffic sent to a merchant web site and substantially obviates one or more of the problems due to limitations and disadvantages of the related art.

Although the current online advertising methods are capable of increasing the value of traffic being directed to the advertiser, many times they are not able to reliably indicate whether a user intends to purchase an item. By having a user interact with a redemption center prior to directing the user to a merchant, the instant systems and methods can more reliably indicate to the merchant that the user intends to purchase an item. By doing so, the value of the traffic directed from the redemption center to the merchant is increased.

Some embodiments comprise a method for providing generalized gift certificates comprising the steps of: collecting user information via a tracking server and storing the user information in a database; generating a purchaser model such that the purchaser model can determine a subset of users, amongst a population of users, that purchase generalized gift certificates, the determination being based upon the user information; serving advertisements for generalized gift certificates to selected users, the selected users being determined by evaluating the user information with the purchaser model, the advertisements allowing the selected users to purchase gift certificates from a redemption center; receiving funds from the user and providing the user with a generalized gift certificate; associating the generalized gift certificate with a user identifier, the user identifier associating the user information stored in the database with the generalized gift certificate; providing a merchant network, the merchant network comprising a plurality of merchants, each merchant capable of accepting generalized gift certificates in exchange for merchandise or services; and, recommending merchants to the user via the redemption center, the recommendation determined by the user information in conjunction with user target parameters.

Some embodiments comprise computer program process code tangibly stored on computer readable media and interpretable by a processor running on a computing device, the computer program process code comprising instructions for providing generalized gift certificates, the instructions comprising modules for implementing: a user computing device, the user computing device communicatively coupled with a communication network; and, a server, the server communicatively coupled with the communication network, the server further comprising: a tracking server, the tracking server collecting user information from a user computing device, the tracking server storing the user information as a plurality of electronic records in a database; a purchaser model, the purchaser model generated by serving advertisements for generalized gift certificates to a subset of users via an advertisement generator and determining which users are likely to purchase generalized gift certificates based upon the user information; and, a redemption center, the redemption center allowing users to purchase generalized gift center, the redemption center capable of recommending merchants based upon the user information in conjunction with user target parameters.

Additional features and advantages of the invention will be set forth in the description which follows, and in part will be apparent from this disclosure, or may be learned by practice of the invention. The objectives and other advantages of the invention will be realized and attained by the structure particularly pointed out in this written description, including any claims contained herein and the appended drawings.

It is to be understood that both the foregoing general description and the following detailed description are exemplary and explanatory and are intended to provide further explanation of the disclosed systems and methods for serving generalized gift certificates to consumers on a web site.

### BRIEF DESCRIPTION OF THE DRAWINGS

The accompanying drawings, which are included to provide a further understanding of the disclosed systems and methods for serving generalized gift certificates to consumers on a web site and are incorporated in and constitute a part of this specification, illustrate various embodiments and, together with the description, serve to explain the principles of at least one embodiment of the disclosed systems and methods for serving generalized gift certificates to consumers on a web site.

In the drawings:

FIG. 1 is a block diagram illustrating components for increasing the value of traffic sent to a merchant web site by serving generalized gift certificates to consumers through a redemption center in accordance with an embodiment.

FIG. 2 is a component diagram of a user computing device in accordance with an embodiment.

FIG. 3 is a block diagram illustrating steps for advertising and selling generalized gift certificates to a user in accordance with an embodiment.

FIG. 4 is an architecture diagram illustrating a system for generating user purchases of generalized gift certificates in accordance with an embodiment.

FIG. 5 is a block diagram illustrating steps for directing users having generalized gift certificates to one or more merchants in the merchant network.

### DETAILED DESCRIPTION

Reference will now be made in detail to embodiments of the disclosed systems and methods for serving generalized gift certificates to consumers on a web site, examples of which are illustrated in the accompanying drawings.

Gift certificates allow a purchaser to give a recipient funds which can be used for purchases at a merchant. Gift certificates are popular for many reasons, including, but not limited to, giving the recipient more freedom in picking out their gift while still signaling that the purchaser put forth effort in giving a gift that the recipient would like. In some instances, a merchant may provide a discount to the purchaser, thereby providing another motivator for the purchase. By way of nonlimiting example, a merchant may offer to sell a purchaser a gift certificate with a face value of $100 for $95. Gift certificates benefit merchants in many ways, including, but not limited to, building customer loyalty, increasing merchant name recognition, allowing the merchant to better predict future demand, and the like.

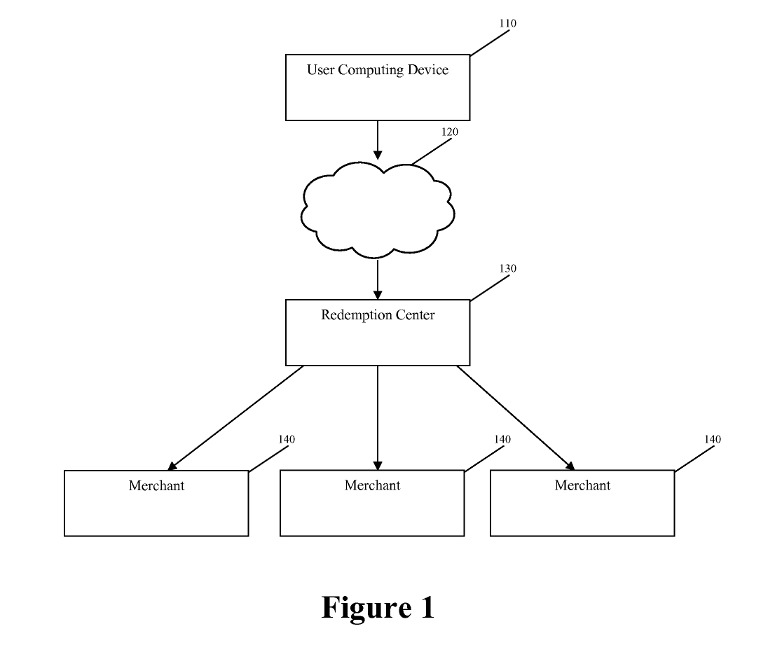

FIG. 1 is a block diagram illustrating components for increasing the value of traffic sent to a merchant web site by serving generalized gift certificates to consumers through a redemption center in accordance with an embodiment. A user, the user having a generalized gift certificate, can access a redemption center 130 via a World Wide Web browser (“browser”), such as Internet Explorer, distributed by Microsoft of Seattle, Wash., or Firefox distributed by Mozilla Corporation of Mountain View, Calif. The browser can be executed on a user computing device 110 communicatively coupled to a communication network 120. Communication network 120 can be a private network or non-private network, such as, but not limited to, the Internet.

User computing device 110 and redemption server 130 can be communicatively coupled to communication network 120 via a variety of means including, without limitation, high-speed wired and wireless communications employing the 802.11 series of standards published by the Institute of Electrical and Electronics Engineers (“IEEE”), cellular telephony, digital data encoded by modulating an analog telephone carrier signal using a modem, or the like. In addition, some or all parts of communications taking place over communication network 120 may be secured using a variety of secure communications methods including, without limitation, Virtual Private Networking (“VPN”), Secure Sockets Layer (“SSL”), the Advanced Encryption Standard (“AES”), Triple Data Encryption Standard (“3DES”), or the like. As used herein, the term server is intended to include, without limitation, computer program process code which, when interpreted by one or more processors running on one or more computers, enables the one or more computers to carry out the functionality associated therewith. As used herein, the term server is not intended to be limited to a single process or thread running on a single processor, or to a single physical device on which the server software is executing.

In some embodiments, redemption center 130 can allow the user to use the generalized gift certificate to purchase merchandise or services from one or more merchants 140. When the user accesses redemption center 130, the user is in effect signaling that he desires to purchase merchandise or services. Traffic directed from the redemption center 130 to merchant 140 may have a higher value to merchant 140 than traffic directed according to other online advertising methods, such as, but not limited to, search advertising, contextual advertising, or the like, because there is a higher probability that the traffic will result in an actual sale. As a result, merchant 140 may be willing to offer a discount on the face value of any goods or services available from the merchant. Such discounts may be passed on to a generalized gift certificate purchaser, generalized gift certificate recipient, received by an operator of the instant system as payment for the merchant's participation in the instant system, or combinations thereof.

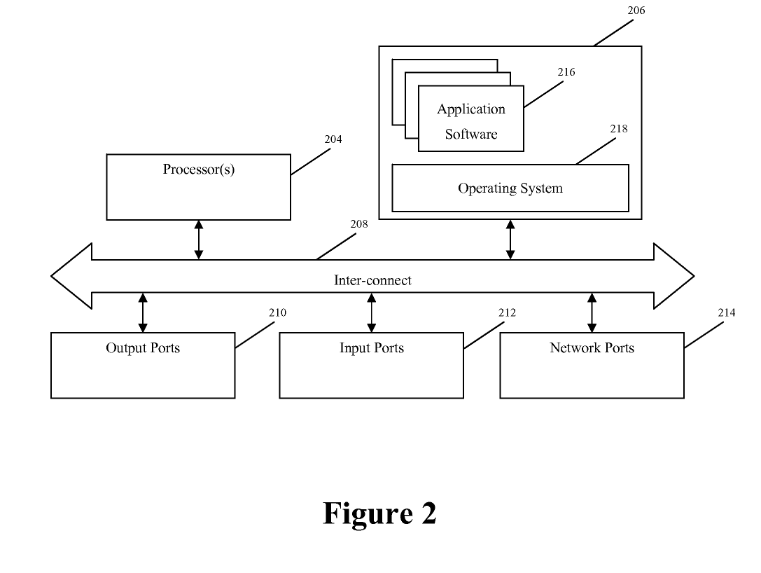

FIG. 2 illustrates a component diagram of user computing device 110, according to some embodiments. User computing device 110 can comprise one or more computing devices, computer processes, or software modules described herein. In one example, user computing device 110 can be utilized to process calculations; execute instructions; receive and transmit digital signals; and, access redemption center 130 and merchants 140 through communication network 120.

User computing device 110 can be any general or special purpose computer now known or to become known capable of performing the steps and/or performing the functions described herein, either in software, hardware, firmware, or combinations thereof. Exemplary user computing devices include, without limitation, personal computers, portable digital assistants, personal music players, cellular telephones, and the like.

In some embodiments, user computing device 110 comprises an inter-connect 208 (e.g., bus, system core logic, or the like), which facilitates communication between the various components of user computing device 110 such as, without limitation, processor(s) 204 and memory 206. Furthermore, interconnect 208 can allow microprocessor 204 and/or memory 206 to communicate with peripheral devices, including those connected via input ports 212 and output ports 210. Input ports 212 and output ports 210 can communicate with I/O devices such as mice, keyboards, modems, network interfaces, printers, scanners, video cameras and other devices. In addition, output port 210 can further communicate with a display.

Interconnect 208 may also comprise one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. Inter-connect 208 can also include one or more network ports 214, through which the user computing device can be communicatively coupled with communication network 120.

In some embodiments, memory 206 may include ROM (Read Only Memory), and volatile RAM (Random Access Memory) and non-volatile memory, such as hard drive, flash memory, computer-readable media, or the like. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. Computer-readable media can include, without limitation, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), or the like.

In some embodiments, memory 206 can be a local device coupled directly to the other components or modules in the data processing system. A non-volatile memory that is remote from the system, such as a network storage device coupled to the data processing system through a network interface such as a modem or Ethernet interface, can also be used.

In some embodiments, routines executed to implement one or more embodiments may be implemented as part of an operating system 218 or a specific application, component, program, object, module or sequence of instructions, collectively referred to herein as application software 216. Application software 216 typically comprises one or more instructions set that can be executed by microprocessor 204 to perform operations necessary to execute elements involving the various aspects of the methods and systems described herein.

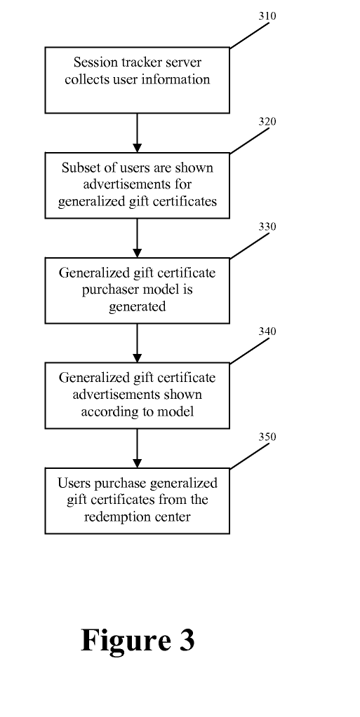

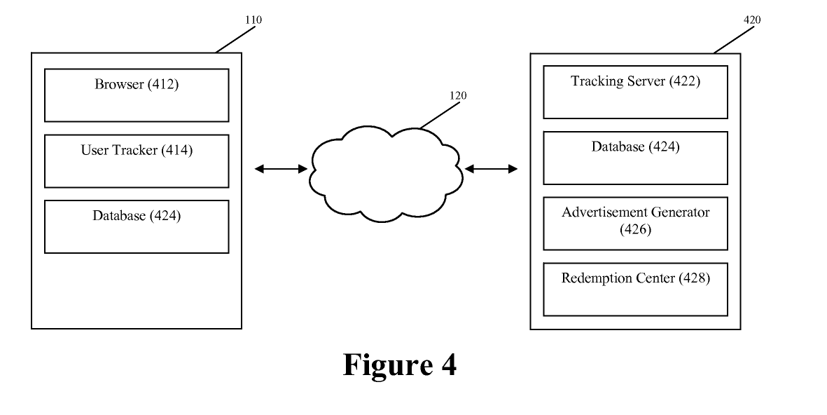

In some embodiments, the system and method can direct advertisements for generalized gift certificates to those users that are more likely to purchase generalized gift certificates. Referring to FIGS. 3 and 4, in step 310 tracking server 422, executing on a server 420 obtains user tracker 414 from user computing device 110 when a first advertisement is served to the user, when a search query is submitted by the user and/or as search results are provided to the user, or the like. User tracker 414 can then be used by tracking server 422 to determine demographic and other information about the user. By way of nonlimiting example, tracking server 422 can record attributes of the pages served when an advertisement is provided, such as, without limitation, keywords in the page; the time of day and day of the week or time of year in which the page is viewed; the number of other users visiting the page; the location associated with the Internet Protocol Address or other network identifier from which the request is originating; the location of the server from which the page is being served or a regional identifier associated with the content being served; information entered by the user in one or more fields on a web page; how frequently the user interacts with advertisements and the nature of such advertisements; and the like. From this, tracking server 422 can begin to build a model of the user based on statistical analyses of the user's behavior and actions. In some embodiments, although the statistical model may not reflect the user's actual demographic information, the statistical model may be more accurate in reflecting the user's purchasing habits. In some embodiments, the user information may be collected and stored in a privacy compliant manner. By way of nonlimiting example, the information collected about the user may specifically avoid capturing the user's name, telephone number, specific street address, social security number, credit card number, and other such personally-identifiable information.

Tracking server 422 may cause portions of the recorded and/or derived information to be stored in one or more databases 424 associated with tracking server 422, or on the user computing device 110. Databases can be used to facilitate rapid searching and retrieval of the user information. Database engines capable of storing the user information include, but are not limited to, Microsoft Access or Microsoft SQL Server distributed by Microsoft Corporation of Redmond, Wash., Oracle Database distributed by Oracle Corporation of Redwood Shores, Calif., or MySQL distributed by MySQL Inc. of Cupertino, Calif.

In some embodiments, user tracker 414 may be provided by a browser 412 in the form of a Hyper Text Transfer Protocol (“HTTP”) cookie, a PHP session mechanism, Yahoo! toolbar, or the like. In some embodiments, user tracker 414 may be provided by a stand-alone application, such as, but not limited to, Yahoo! Messenger, Yahoo! Desktop, or the like, at the start of a browsing session or as each page is requested or viewed.

In some embodiments, as illustrated in FIG. 4, user computing device 110 and server 420 are communicatively coupled to communication network 120. Data exchange between user tracker 414 executing on user computing device 110 and tracking server 422 executing on server 420 occur via communication network 120. Communication network 120 can be a private network or non-private network, such as, but not limited to, the Internet.

User computing device 110 and server 420 can be communicatively coupled to communication network 120 via a variety of means including, without limitation, high-speed wired and wireless communications employing the 802.11 series of standards published by the Institute of Electrical and Electronics Engineers (“IEEE”), cellular telephony, digital data encoded by modulating an analog telephone carrier signal using a modem, or the like. In addition, some or all parts of communications taking place over communications network 220 may be secured using a variety of secure communications methods including, without limitation, Virtual Private Networking (“VPN”), Secure Sockets Layer (“SSL”), the Advanced Encryption Standard (“AES”), Triple Data Encryption Standard (“3DES”), or the like.

In some embodiments, the above described functionality associated with server 420 may be provided by multiple servers to scale the system architecture to meet demand. Furthermore, individual components of server 420, e.g., database 424, may be provided by a separate server or group of servers.

Referring back to FIG. 3, in block 320 advertisement generator 426 displays advertisements for generalized gift certificates to a subset of users visiting a site or otherwise being served an advertisement. In some embodiments, the subset may be chosen on a wholly random basis. In some embodiments, the subset may initially be randomly chosen and then systematically modified to account for any deficiencies present in the initial subset. In some embodiments, the initial subset may be chosen from those who have purchased from participating merchants in the past, or who previously purchased one or more gift certificates.

In block 330, a generalized gift certificate purchaser model (referred to hereinafter as “purchaser model”) is generated. The purchaser model is generated by detecting trends in the user information amongst those users in the subset chosen in block 320 who responded to the generalized gift certificate advertisements by purchasing generalized gift certificates. By way of example, without limitation, the purchaser model may indicate that users who frequent bargain web sites in the evening are most likely to purchase generalized gift certificates. In various embodiments, level of granularity of the purchaser model can vary, specifically targeting small subsets or users or defining trends for a large portion of the population of users.

In block 340, advertisement generator 426 generates advertisements for generalized gift certificates and displays them to users matching the purchaser model parameters. The advertisements provide the user with a link to purchase generalized gift certificates from redemption center 428. In some embodiments, advertisement generator 426 displays the same advertisement to each user identified by the purchaser model. In some embodiments, advertisement generator 426 can generate user specific advertisements. By way of example, without limitation, advertisement generator 426 may generate a generalized gift certificate advertisement containing pictures of electronics in the background for a user that frequents electronics related web sites. In some embodiments, advertisement generator 426 may be provided by a web application server. Suitable web application servers may include, but are not limited to, Internet Information Services (“IIS”) distributed by Microsoft Corporation of Redmond, Wash. or Apache HTTP Server distributed by the Apache Software Foundation.

In block 350, the user can purchase a generalized gift certificate from redemption center 428. In some embodiments, the purchase price of the generalized gift certificate may be less than the merchandise value of the generalized gift certificate. By way of example, without limitation, the user might be charged $95 for a generalized gift certificate having a value of $100. The user may purchase a generalized gift certificate for personalized use or the user may give the generalized gift certificate to another individual.

In some embodiments, the generalized gift certificate can be delivered to the user via a hyperlink contained in an email. The hyperlink can allow the user to perform any of a number of functions, including, without limitation, forward the received generalized gift certificate to another user and associate the generalized gift certificate with a user identifier, such as, but not limited to, Yahoo! ID, an HTTP cookie, or the like. Associating the gift certificate with a user identifier can allow the user to consolidate the value of a plurality of received gift certificates, and to transfer some or all of the consolidated value to another user or users. The association of a user identifier with the gift certificate can also allow the instant system to serve specific advertisements to users who have received a generalized gift certificate. By way of example, without limitation, a user with a $50 generalized gift certificate balance who searches for “desk chair” can be shown advertisements for desk chairs that cost $50 or less. In some embodiments, the user identifier can be used to remind users that they have a general gift certificate balance. In some embodiments, the user may be served an advertisement for a product whose cost is only marginally greater than the generalized gift certificate value. Such advertisements may be limited to products having a cost within a fixed percentage, fixed dollar amount, or the greater or lesser thereof, above the generalized gift certificate balance. By way of example, without limitation, a user having a $50 generalized gift certificate balance may receive advertisements for products costing between $50 and $60.

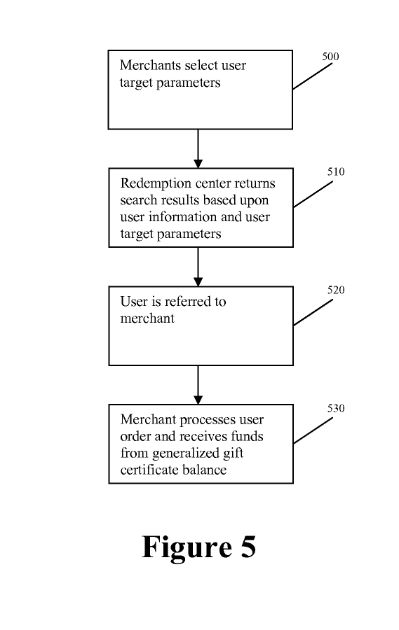

FIG. 5 is a block diagram illustrating steps for directing users having generalized gift certificates to one or more merchants participating in the merchant network. In block 500, each merchant selects one or more user target parameters to define the type of user to whom the merchant wants to be recommended. User target parameters can include, but are not limited to, user demographic or other user information, keywords in a search result or web page being served to the user, generalized gift certificate balance, time of day, or the like. By way of example, without limitation, a high-end watch manufacturer may wish to advertise to users with generalized gift certificate balances over $1000 and whose user information suggests that they have purchased other high-end goods in the past.

In block 510, the user accesses the redemption center to redeem part or all of their generalized gift certificate balance. In some embodiments, the redemption center displays advertisements to the user upon access. In some embodiments, the redemption center provides a search feature so that the user can search amongst the merchant network for merchants offering specific items or categories of items. The search results and advertisements served to the user may be generated in part based upon the user information associated with the user and the user target parameters.

In block 520, the user is referred to a specific merchant, by selecting or otherwise interacting with a link provided in either the search results or an advertisement on the redemption center. In block 530, the merchant processes the user order and receives all or a portion of the associated funds. Such funds may be provided, in part, from the generalized gift certificate balance, and transaction-related fees may be withheld by the redemption center.

While detailed and specific embodiments of the system and method for recommending songs have been described herein, it will be apparent to those skilled in the art that various changes and modifications can be made therein without departing from the spirit and scope of the system and method for recommending songs. Thus, it is intended that the present disclosure cover these modifications and variations provided they come within the scope of any appended claims and/or their equivalents.

What is claimed is:

1. A system for facilitating the redemption of a generalized gift certificate, comprising:
a tracking server, the tracking server collecting a user tracker from a computing device associated with the user, the tracking server storing the user tracker as a record in a database, the database being stored on computer readable media, the tracking server further obtaining user information about a user and associating the user information with the user tracker, the tracking server storing an association between the user tracker and a generalized gift certificate;
a redemption center server, the redemption center server storing a balance associated with the generalized gift certificate; and,
an advertising server, the advertising server obtaining the user tracker from the user computing device and the generalized gift certificate balance from the redemption center server, the advertising server serving advertisements to the user in response to a user request, the advertisements comprising advertisements for products available from merchants accepting the generalized gift certificate and in which the user information suggests the user is likely to be interested.

2. The system of claim 1, the advertisements further comprising advertisements for products with a value equal to or less than the generalized gift certificate balance.

3. The system of claim 2, the advertisements further comprising products having a value equal to or greater than the generalized gift certificate balance by a certain percentage or a certain value limit.

4. The system of claim 1, the generalized gift certificate balance obtained from the redemption center server comprising an aggregate of the values of a plurality of generalized gift certificates associated with the user tracker.

5. The system of claim 1, the tracking server filtering the user information to remove personally identifiable information.

6. The system of claim 1, the generalized gift certificate being redeemable at a plurality of participating merchants.

7. The system of claim 1, the user tracker comprising an HTML cookie.

8. The system of claim 1, the user information comprising demographic information about the user associated with the user tracker.

9. The system of claim 1, the user information comprising a history of purchases made by the user associated with the user tracker.

10. A method for providing generalized gift certificates comprising the steps of:
reading a first user tracker from a first user computing device as a request is received from the first user computing device, the request comprising at least one of an advertisement request and a search request;
storing user information in a database, the user information associated with the first user tracker and derived at least in part from one of the received request and results to be served in response to the request;
generating a purchaser model which facilitates identifying users who are likely to purchase generalized gift certificates based on user information associated with the user computer associated with the users who purchase such generalized gift certificates;
serving a first advertisement for generalized gift certificates to the first user computing device if the user information associated with the user tracker associated with the user device corresponds to the purchaser model;
receiving funds and providing the user with a generalized gift certificate;
associating the generalized gift certificate with a second user tracker; and
serving a second advertisement to a second computing device associated with the second user tracker.

11. The system of claim 10, the serving of the second advertisement comprising:
identifying at least one product in which a second user associated with the second user tracker is likely to be interested, the identification based at least in part on user information associated with the second user tracker and stored in the database; and,
serving an advertisement for the identified at least one product to the second computing device.

12. The system of claim 10, the second advertisement comprising an advertisement for a product with a value equal to or less than the generalized gift certificate balance.

13. The system of claim 12, the second advertisement further comprising an advertisement for a product having a value equal to or greater than the generalized gift certificate balance by a certain percentage or a certain value limit.

14. The system of claim 10, the advertisements further comprising advertisements for products with a value greater than the generalized gift certificate balance.

15. The system of claim 10, the associating the generalized gift certificate with a second user tracker further comprising adding the value of the generalized gift certificate to a generalized gift certificate balance associated with the second user tracker.

16. The system of claim 10, the user information stored in the database being stripped of personally identifiable information.

17. The system of claim 10, the generalized gift certificate being redeemable at a plurality of participating merchants.

18. The system of claim 10, the first and second user trackers comprising separate HTML cookies.

19. The system of claim 10, the user information comprising demographic information about the user associated with the user tracker.

20. The system of claim 10, the user information comprising a history of purchases made by the user associated with the user tracker.

21. Computer readable medium having stored thereon computer readable instructions executable by a processor, the instructions when executed comprising:
a tracking server, the tracking server collecting a user tracker from a computing device associated with a user, the tracking server storing the user tracker as a record in a database, the database being stored on computer readable media, the tracking server further obtaining user information about a user and associating the user information with the user tracker;
a purchaser model generator, the purchaser model generator generating a purchaser model by serving advertisements for generalized gift certificates to a set of users via an advertisement generator and determining which users are likely to purchase generalized gift certificates based upon the user information;
an advertising generator, the advertisement generator communicatively coupled to the purchaser model generator and the tracking server, the advertisement generator collecting the user tracker from the computing device associated with the user, retrieving the information associated therewith from the database, comparing the user information to the purchaser model and, if the user is identified by the purchaser model as a user likely to purchase generalized gift certificates, directing an advertisement to the user advertising such generalized gift certificates, and,
a redemption center server, the redemption center server communicatively coupled to the tracking server and the purchaser model generator via a communication network, the redemption center server providing a web page, viewable by a browser running on the user computing device, through which a generalized gift certificate can be purchased.

22. The computer program process code of claim 21, the generalized gift certificate being redeemable at a plurality of participating merchants.

23. The computer program process code of claim 21, the user tracker comprising an HTML cookie.

24. The computer program process code of claim 21, the user information comprising demographic information about the user associated with the user tracker.

25. The computer program process code of claim 21, the user information comprising a history of purchases made by the user associated with the user tracker.
